(19) United States
(12) Patent Application Publication
(10) Pub. No.: US 2002/0174002 A1
(43) Pub. Date: Nov. 21, 2002

(54) Method for parameter management for business process workflows

(76) Inventor: Huba Horompoly, Redwood City, CA (US)

Correspondence Address: RANDY MERRITT, 15505 W. ST ANDREES WAY, SURPRISE, AZ, 85374, US

(21) Appl. No.: 10/143,609

(22) Filed: May 10, 2002

Related U.S. Application Data
(60) Provisional application No. 60/291,899, filed on May 18, 2001.

(51) Int. Cl. G06F 9/46; G06F 17/60

(52) U.S. Cl. 705/7

(57) ABSTRACT

A method for providing a storage area for task parameters for user input, task output, and the exchange of information between task steps of a business process workflow is provided. The storage area can store information based on a variety of data types. The storage area also includes information on the storage requirements of a task for its input and output, plus the storage and information exchange needs for the individual steps performed by a task.

### BACKGROUND OF THE INVENTION

### Field of the Invention

This application is related to commonly assigned, co-pending application entitled System And Method For Dynamic Access Of Information Over A Wireless Network filed on the same date as the present application by the same inventor. The present invention relates generally to a method of managing input and output parameters on behalf of tasks involved in a Business Process workflow.

### OBJECTS OF THE PRESENT INVENTION

It is therefore an object of the present invention to provide a method for defining and managing a storage area that serves as an input and output area on behalf of parameters of tasks executing a Business Process.

It is a further object of the present invention to provide a storage area that can store information based on data types either proprietary to the present invention, or on industry-standard data types, or on types defined or supplied by a third-party.

It is still a further object of the present invention to provide for the repeated execution of the same Business Process using different slot associations based on different backend systems.

It is a further object of the present invention to provide for the association of a slot with multiple Business Process parameters at different levels of a workflow.

It is yet a further object of the present invention to provide for the definition of a slot's data type based on its association with a Business Process parameter.

It is a further object of the present invention to provide for the conditional execution of a Business Process within a task, based on decision branches within the task.

It is a further object of the present invention to provide for the inclusion of a sequence number associated with both input and output parameter pool slots, which define the order in which the fields of a Business Process are displayed to a user.

It is still a further object of the present invention to provide for the inclusion of a system identifier within a slot cell that records the particular ERP system from which the associated results originated.

It is yet a further object of the present invention to provide for the definition of aggregate functions that may be applied to the output of the execution of Business Processes from multiple ERP systems.

### SUMMARY OF THE INVENTION

The present invention comprises a method for providing a storage area in the form of a parameter pool to serve as storage for task parameters used to receive user input, provide for task output, and exchange information between processing steps during the execution of a Business Process task. A parameter pool slot represents an allocatable unit of such storage. This storage unit can store information based on a variety of data types. The definition of the Parameter Pool contains the information on the storage needs of the task for its input and output, plus the storage and information exchange needs for the individual steps performed by the task.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a schematic view of the parameter slot cell allocation structure capable of embodying the method of the present invention.

### DESCRIPTION OF THE PREFERRED EMBODIMENTS

The following description is provided to enable any person skilled in the art to make and use the invention and sets forth the best modes presently contemplated by the inventors of carrying out their invention. Various modifications, however, will remain readily apparent to those skilled in the art, since the generic principles of the present invention have been defined herein.

A task is defined, in the context of the present invention, as a general unit of work. The present invention comprises a system and method for providing a storage area for such tasks in the form of a Parameter Pool. This Parameter Pool serves as an area for tasks to store parameters that are used to receive user input, provide for task output, and exchange information between processing steps during task execution. These tasks may be either internal to an embodiment of the present invention or external from third party sources. The Parameter Pool provides a data exchange area for steps within a task (input-output area for the steps) as well as defining certain input-output presentation characteristics.

Parameter Pools are defined for each task. A task may have only one Parameter Pool. One instance of a Parameter Pool is created for each task at runtime and implements a defined structure. The definition of the Parameter Pool contains the information on the storage needs of the task for its input and output, plus the storage and information exchange needs for the individual steps performed by the task.

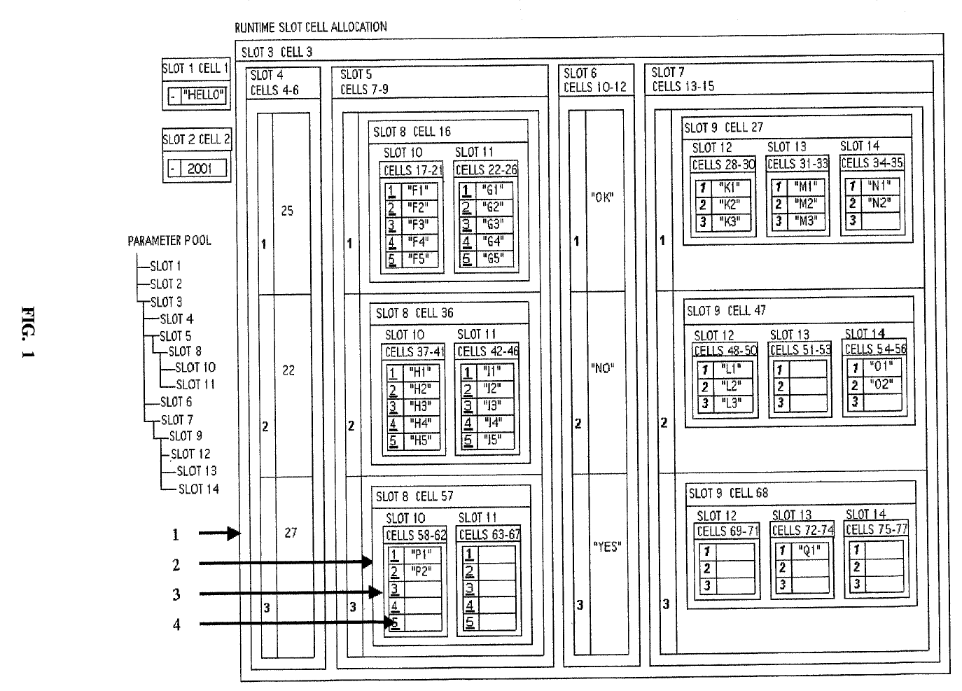

Referring now to FIG. 1, a parameter pool contains one or more slots. A parameter pool slot, shown at 1, represents a unit of storage. This storage area can store information based on data types proprietary to the present invention or standard data types or third party defined data types. A slot can be defined in terms of other slots shown at 2. In this case, the parent slot is a container “table” because it doesn't hold data of it's own and the child slots are the columns in the table shown at 3.

The key steps in a task are the internal or external Business Processes, which have their own input and output parameters. When a task is created and a Business Process is added as part of the task, links must be defined associating the Parameter Pool slots and with the Business Process parameters. By linking the Parameter Pool slots with the Business Process parameters the Business Process will retrieve its input data from a selected slot or will place any result parameters into selected slots for its output. By associating the slots with the Business Process parameters, the Business Process task will know where to get it's input and where to put it's output of the Business Process at execution time.

A task may execute the same Business Process more than once using different slot associations with different backend systems. Furthermore, a slot can be associated with multiple Business Process parameters at different levels of a workflow. For example, many Business Processes may take their input from the same slot while other processes might modify the slot content concurrently. For these reasons the association not only links the slot with the Business Process parameter but also includes the particular instance of a Business Process within a task, since the management of Business Processes needs to determine which instance of a Business Process within a task where it can find the corresponding parameters. This instance is called the Business Process of the task, which has its own execution parameters and other characteristics.

A Business Process parameter associated with a slot defines the data type of the slot by having a link to a Business Field, the central repository of usable fields. The slot does not have a data type of it's own. It points to a Business Field, which has a data type defined.

Business Processes may execute conditionally based on decision branches in the task. A Business Process executes if a decision branch evaluates to true else it does not. This can be due to user decisions or other conditions that possibly prevent the execution from reaching the Business Process. An input parameter may be marked as not applicable to a task and this task will then be presented to the user only if it becomes certain that the Business Process will be executed. If a Business Process parameter is mandatory, the task input parameter is so marked and the user input is forced into the field. A corresponding method is employed for all output parameters identified in a task by finding all output parameters of the corresponding Business Processes.

Each slot has a language dependent name for easy identification. Each organization can have a different name and each language within an organization can define a different name for a slot. Naming the slot assists in creating task specific identifiers for the task fields. An optional description can be defined for each slot, even in a language dependent way. The names of the slots are the default text for the labels of corresponding fields on the user's screen.

Two other attributes of a Parameter Pool slot are the Input Sequence Number and the Output Sequence Number 4. These numbers define the order in which the fields are displayed to the user. If the task input provided by the user is, for example, ERP system specific, the ERP system identifier is stored in the slot cell. In the case of a task's output, if a Business Process is executed on multiple ERP systems which are configured in the task and each of them returns a result, then each of these results may be stored in the Parameter Pool, with each slot cell marked with the appropriate ERP system identifier. In the case where a business process receives multivalued output of a previously executed Business Process within the same task, the Business Process receiving the input will need to receive it in a single-valued form since a Business Process can only take a single value of its parameters.

It is possible for a task to define aggregate functions to be applied to the output of multiple ERP system Business Processes. Aggregate functions such as “take the Maximum value” or “take the Minimum value” and the like may be applied to the returned data and the output values of such aggregate functions may, in turn, be used as input to subsequent parameters. In this case the ERP system information will be cleared and the receiving Business Process must be able to interpret the data without it. The aggregate functions can be defined independently from the requirement of the passing of data.

For some information the ERP system identifier is ignored when used with input, whereas it can be very important if handled with output. For example, the output could be the number of units in stock. For this number it is significant to know to which ERP system this value would apply. If the very same information is used as the input for a Sales Order Business Process that specifies the number of units to order, the ERP system information in that slot cell would not be relevant.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A method for storage allocation for use with tasks in association with business process workflow comprising:
a memory area for tasks to store parameters that are used to receive user input, provide for task output, and exchange information between processing steps during task execution;
an associated slot within the storage area that contains information on the storage needs of a task in regards to its input and output as well as the storage and information exchange needs for the individual steps performed by the task;
the association of task steps to internal or external Business Processes, which have input and output parameters of their own;

2. The method of claim 1 further comprising:
a storage area that can store information based on data types proprietary to the present invention;

3. The method of claim 1 further comprising:
a storage area that can store information based on data types recognized as industry-standard data types;

4. The method of claim 1 further comprising:
a storage area that can store information based on data types defined by sources external to the present invention;

5. The method of claim 1 further comprising:
a method for the repeated execution of the same Business Process, with each execution instance using a slot associated with a different backend system;

6. The method of claim 1 further comprising:
a method for associating a slot with multiple Business Process parameters at different levels of a workflow;

7. The method of claim 1 further comprising:
a method for defining a slot's data type based on its association with a Business Process parameter;

8. The method of claim 1 further comprising:
a method for the conditional execution of a Business Process within a task based, on decision branches within the task;

9. The method of claim 1 further comprising:
a method for the inclusion of a sequence number associated with both input and output parameter pool slots, which define the order in which the fields of a Business Process are displayed to a user;

10. The method of claim 1 further comprising:
a method for the inclusion of a system identifier within a slot cell that records the particular ERP system from which the associated results originated;

11. The method of claim 1 further comprising:
a method for defining aggregate functions that may be applied to the output of the execution of Business Processes from multiple ERP systems.
